(19) United States
(12) Patent Application Publication
(10) Pub. No.: US 2017/0014989 A1
(43) Pub. Date: Jan. 19, 2017

(54) SCAFFOLD TRAY AND TOOL CASE

(71) Applicant: Steven McGee, Dallas, TX (US)

(72) Inventor: Steven McGee, Dallas, TX (US)

(21) Appl. No.: 15/210,042

(22) Filed: Jul. 14, 2016

Related U.S. Application Data
(60) Provisional application No. 62/192,452, filed on Jul. 14, 2015.

(51) Int. Cl. B25H 3/02; B65D 25/24

(52) U.S. Cl. CPC B25H 3/02; B65D 25/24

(57) ABSTRACT

A scaffold tray and tool case for holding and storing tools upon a scaffold. The tray surface includes openings of various sizes to accommodate tools. The tray surface has raised walls to prevent unsecured tools from rolling off of the tray surface. The tray surface includes rung cutouts and cutout fasteners to secure the tray to the rung. The rear support leg includes tool, storage and tool straps to secure tools to the interior of the rear support leg. The tray surface is immobilized and connected to the roar support legs via fasteners. A folding support connects the tray surface and support leg to facilitate folding and storage of the scat fold tray and tool case. The rear leg includes rung strap openings to secure the device to the scaffold. There are carrying straps on the front side wail and rear support leg to facilitate carrying and opening the folded device.

The present disclosure relates generally to a support tray and, in particular, to a scaffold tray for storing work tools.

### BACKGROUND

Scaffolds are commonly used by work crews during construction or repair on building, bridges and other structures. Scaffolds are particularly helpful and useful when the workers must be elevated at a height away from the ground in order to perform the work tasks. Often times, tools are required to perform the work tasks. Workers typically place the tools on the scaffold surface, which presents a hazard for the tool (which may fall and break), the worker (who way drop and damage a tool, trip on a tool and fall from the scaffold, or drop a tool to the ground below, possibly endangering unsuspecting passersby. Alternatively, a worker may try to balance the tool between their legs or between their arm and torso in order to multitask without setting the tool on the scaffold. To resolve this issue, scaffold trays have been created and improved upon over the years. However, prior embodiments of the scaffold tray have multiple limitations such as accommodating round or square rungs but not universal fit for any rungs, not folding for easy storage, and not having storage space for tools.

An object of one embodiment of the present disclosure is to provide a sturdy and secure resting area for tools in use by a worker on a scaffold.

Another object of the present disclosure is to provide a storage space for worker's tools.

Another object of the present disclosure is to provide a scaffold tray that can universally fit virtually any scaffold rung shape or size.

Another object of the present disclosure is to provide a scaffold tray that can fold and collapse for storage and transport.

### SUMMARY

Embodiments of the present disclosure generally provide a scaffold tray and tool case (“STTC”) that attaches to the horizontal rung of a scaffold. The STTC is comprised of a tray surface, rear support legs, leg fastener, and folding supports. The tray surface and support legs are attached to each other with metal fasteners and folding supports at; a ninety degree (90°) angle. The rear support legs may be individual legs or a single rear leg unit with a connection between the right and left leg (U-shaped in this embodiment). The folding supports allow the STTC to fold for storage and unfold for attachment to a horizontal rung of a scaffold. When the STTC is folded, tools may toe stored inside the STCC. Additionally, the interior surface of the leg unit includes tool straps to further secure any tools stored against the leg unit surface.

The tray surface is comprised of a flat, elongated tray with tray surface openings that pass through from the top to bottom of the tray surface. The tray surface openings may hold tools and other items for storage on the STTC. As mentioned, tools may also be stored against the rear leg unit with tool straps. The tray surface also includes tray side walls on three (3) edges, which are higher than the tray surface in order to prevent any tools stored or placed on the tray surface from rolling off of the tray surface. The rear edge of the tray surface, which does not have a tray surface side wall, has dual cut out sections, which facilitate the resting of the tray surface on the rung of the scaffold. The dual cut out section are circular and round in this embodiment but may also be constructed with straight edges to accommodate square shaped rungs. Additionally, the size of the cut out sections may vary to accommodate rungs of different diameters. The tray surface cut cuts further secure or hook the tray surface to the scaffold rung. In addition to the tray surface cut outs, the tray surface includes cut-out fasteners (cutout locking devices) that secure the tray surface cut outs and rungs in order to stabilize the STTC. The cutout locking devices are attached to the rear bottom of the left side wall and the rear bottom of the right side wall. The cutout locking devices may be moved to a closed position after the STTC is positioned on a horizontal rung of the scaffold, which closes the circular cut out on the STTC, securing the STTC to the scaffold rung. With the cutout locking device in a closed position, the STTC cannot be bumped or lifted from the horizontal rung unless the cutout locking devices are moved into an open position.

The rear support legs are attached to the tray surface with fasteners, at a point directly adjacent to the tray surface cut outs. The rear support legs are also perpendicular to the tray surface, creating a ninety (90) degree angle between the tray surface and rear support leg. In this embodiment, the rear support leg is a single “U-shaped” unit. While the tray surface hooks on a rung, the support legs rest against the rung(s) immediately below the rung on which the tray surface is hooked. The rear support leg also includes dual rung strap openings wherein a strap of Velcro or other material may be inserted through the rung strap opening to tie the rear support leg to the rung of the scaffold for further securing the STTC to the scaffold. A right folding support connects a midpoint of the tray surface right sidewall to the right rear support leg. A left folding support connects a midpoint of the tray surface left side wall to the left rear support leg. The folding supports between the sidewalls and rear support leg permit the STTC to collapse for storage and moving between locations. Additionally, tools may be stored against the surface of the rear support leg that is not adjacent to the scaffold rung. Tools placed against the rear support leg may be secured with tool straps on the rear support leg. The STTC can be used with various scaffold rung settings, scaffold heights, width of scaffold rung, distance between rungs, and scaffold rung shapes. The light weight STTC is convenient to carry and may be used for square and round scaffold legs, small/medium/large scaffolds, and the STTC is collapsible and can be used as a tool carrying case as well as a scaffold tray.

Other technical features may be readily apparent to those skilled in the art from the following figures and descriptions.

### BRIEF DESCRIPTION OF THE DRAWINGS

For a more complete understanding of this disclosure and its features, reference is now made to the following description, taken in conjunction with the accompanying drawings, in which:

FIG. 1 is a top perspective view of the STTC according to one embodiment of the present disclosure;

FIG. 2 is a side perspective view of the STTC according to one embodiment of the present disclosure; and

FIG. 3 is a top plan view of the STTC according to one embodiment of the present disclosure;

FIG. 4 is a front view of the STTC with tools according to one embodiment of the present disclosure;

FIG. 5 is a top side perspective view of the STTC on a scaffold according to one embodiment of the present disclosure.

FIG. 6 is side perspective view of the STTC in a closed position according to one embodiment of the present disclosure.

### DETAILED DESCRIPTION

The present disclosure for the STTC generally provides a scaffold tray and tool case for holding and storing work tools in a secure manner on a scaffold. It should be understood that reference numbers shown in the figures are for illustrative purposes only and that any other system or subsystem could be used in conjunction with or in lieu of these reference numbers according to one embodiment of the present disclosure. These figures include the following references: tray surface 1, tray surface openings 2, tray side walls 3, rear tray surface edge rear support leg 5, rung cut-outs 6, tray fastener 7, folding supports 8, tool straps 9, rung leg strap opening 10, STTC carrying strap 11, rung cut-out; fastener 12.

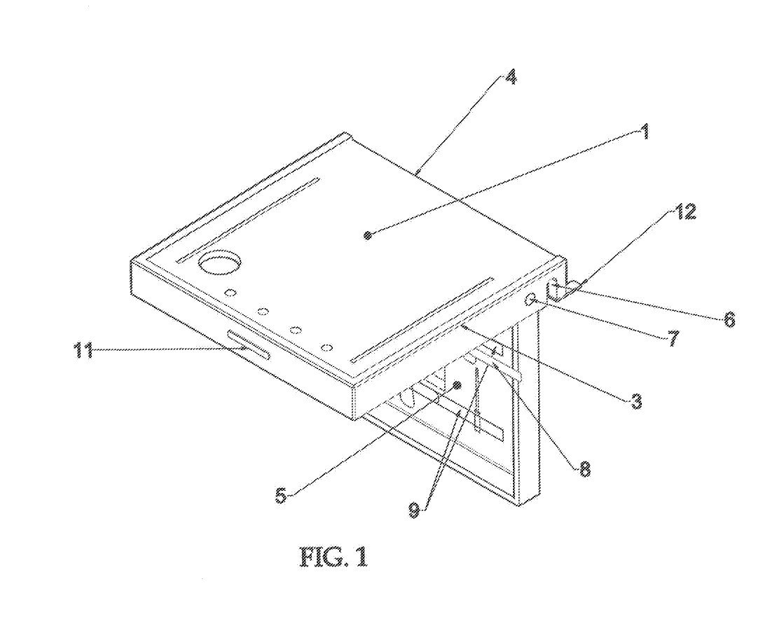

FIG. 1 is a top perspective view of the STTC according to one embodiment of the present disclosure. The tray surface of the STTC contains several openings for the secure placement of tools such as hammers, cordless drills, screwdrivers, putty knives, drywall finishing trowel, and other items. The tray surface 1 has three (3) raised side walls 3 to prevent, tools from rolling off of the tray surface. The rear tray surface edge 4 does not have a raised side wall. The bottom of the rear tray surface edge includes at least two (2) rung cutouts 6 for hugging a rung of the scaffold unit. In addition to the cutouts, the rear tray surface edge includes at least two (2) cutout fasteners 12 or locking devices to secure the tray surface cutout to the scaffold rung. The top of the rear support leg 5 is attached to the bottom of the tray surface 1 at a point adjacent to the tray surface rung cut outs and secured with a tray fastener 7. Folding supports 8 also connect a midpoint of the side wall 3 to a midpoint of the rear, support leg 5. The rear tray leg 5 also has tool straps 9 to secure tools placed against the rear support leg. The STTC also includes a carrying strap 11 at a front side wall for transporting the closed STTC.

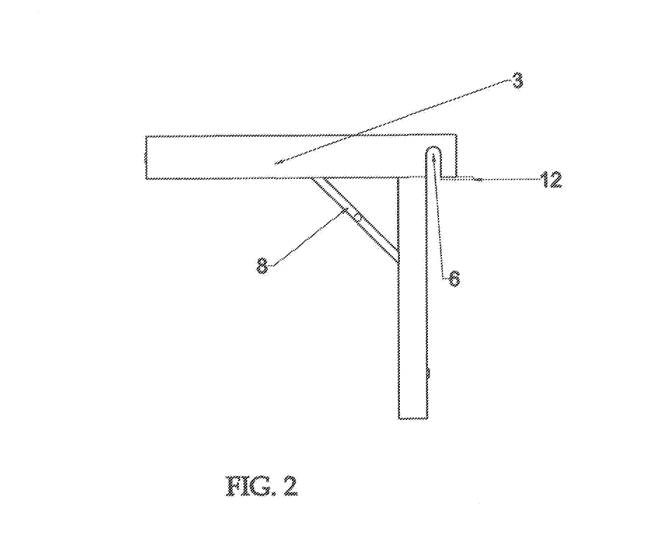

FIG. 2 is a side perspective view of the STTC according to one embodiment of the present disclosure. The tray surface has three (3) raised aide walls 3 around at the edges of the tray surface. The bottom of the rear tray surface edge includes at least two (2) rung cutouts 6 for hugging a rung of the scaffold unit. The rear tray surface edge includes at least two (2) cutout fasteners 12 to secure the tray surface cutout to the scaffold rung. The top of the rear support legs are attached to the bottom of the tray surface at a point adjacent to the tray surface rung cut outs. Folding supports 8 also connect a midpoint of the side wall to a midpoint of the rear support leg.

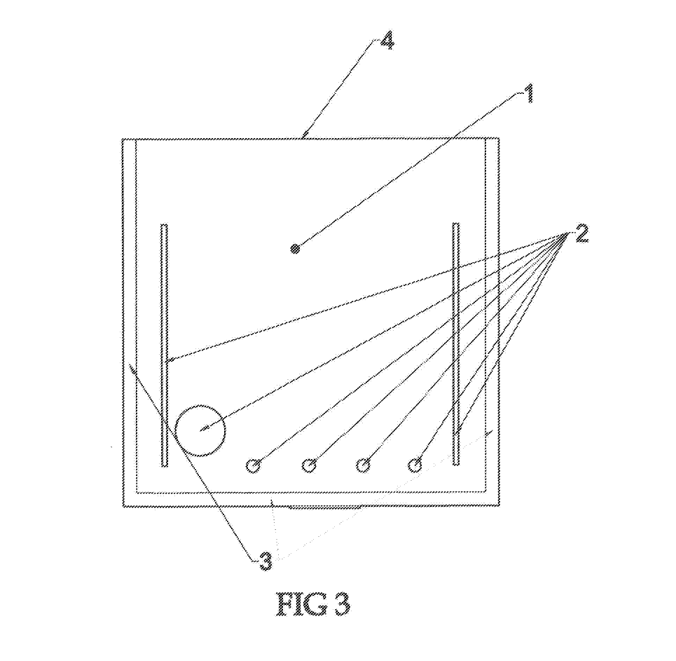

FIG. 3 is a top plan view of the STTC according to one embodiment of the present disclosure. The tray surface 1 of the STTC contains several tray surface openings 2 for the secure insertion and placement of tools and other items. The tray surface 1 has three raised side walls 3 to prevent tools from roiling off of the tray surface, The rear tray surface edge 4 does not have a raised wall.

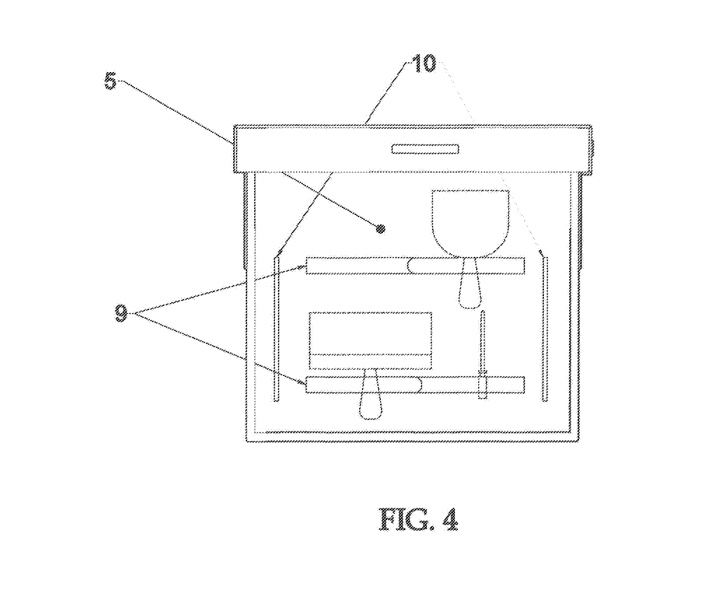

FIG. 4 is a front view of the STTC according to one embodiment, of the present disclosure. This view is a direct view of the interior surface of the rear support leg 5 that would be inside the closed STTC. Only the front edge and side wall of the tray surface is visible in this view. Tools may also be stored on the interior surface of the rear support leg 5 and further secured with tool straps 9, which hold the tools against the interior of the rear support leg. The interior of the rear support leg also includes two (2) rung strap openings 10 in which a length of material may be inserted to connect the STTC to the rung of the scaffold providing additional, stability for the STTC and preventing movement of the STTC while in use with a scaffold unit.

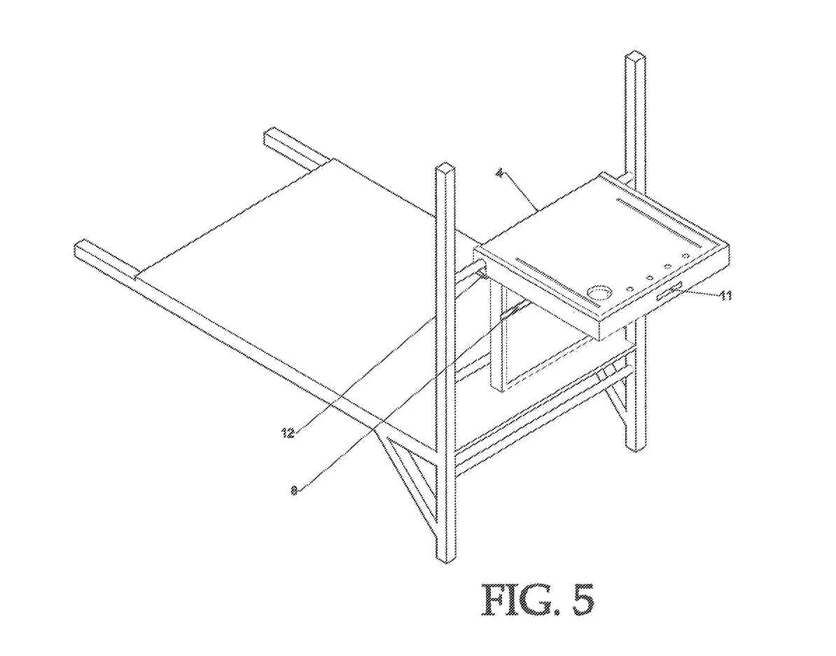

FIG. 5 is a top side perspective view of the STTC on a scaffold unit according to one embodiment of the present disclosure. The tray surface of the STTC contains several openings for the secure placement of tools and other items. The tray surface has three (3) raised side walls to prevent tools from rolling off of the tray surface. The front edge and side wall includes a carrying strap 11 for the STTC. The rear tray surface edge 4 does not have a raised side wall. The bottom of the rear tray surface edge includes rung cutouts to facilitate the STTC hugging a rung of the scaffold unit. In addition to the rung cutouts, the rear tray surface edge includes at least two (2) rung cutout fasteners 12 to secure the tray surface cutout to the scaffold rung. Once the STTC is placed on a scaffold unit with the rung cutouts hanging on a scaffold run, the rung fasteners can be moved from an open position to a closed position in order to secure the rung cut out against the scaffold rung. The top of the rear support legs are attached to the bottom of the tray surface at a point adjacent to the tray surface rung cut outs. Folding supports 8 also connect a midpoint of the side wall to a midpoint of the rear support leg.

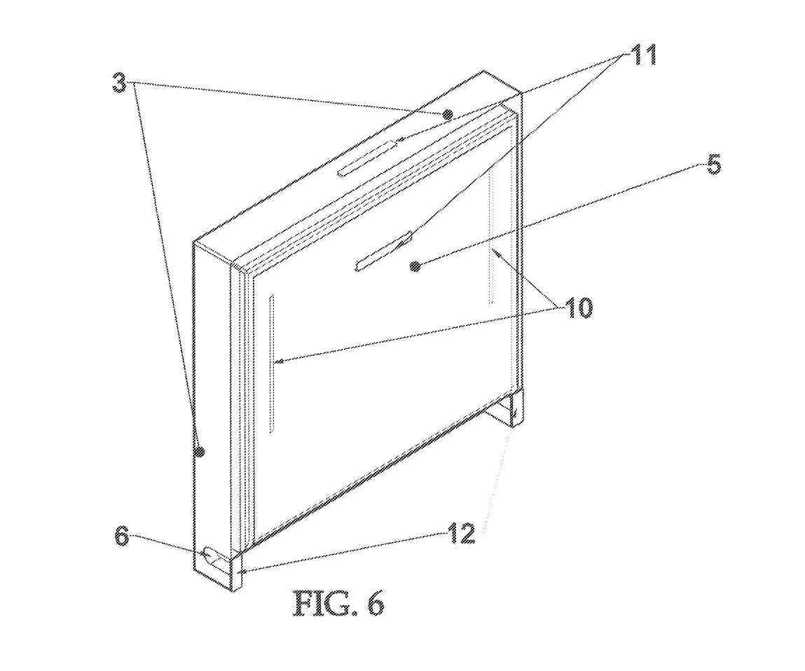

FIG. 6 is side perspective view of the STTC in a closed position. The tray surface has raised side walls 3. The bottom of the rear tray surface edge includes at least two (2) rung cutouts 6 for hugging a rung of the scaffold unit and at least two (2) cutout fasteners 12 or locking devices to secure the tray surface cutout to the scaffold rung. The interior of the rear support leg 5 also includes two (2) rung strap openings 10 in which a length of material may be inserted to connect the STTC to the rung of the scaffold unit. The STTC also includes carrying straps 11 at a front side wall and at the exterior surface of the rear support leg for transporting and opening the closed STTC.

It may be advantageous to set forth definitions of certain words and phrases used in this patent document. The term “couple” and its derivatives refer to any direct or indirect communication between two or more elements, whether or not those elements are in physical contact with one another. The terms “include” and “comprises” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure and the following claims.

What is claimed is:

1. A scaffold tray and tool case comprising:
a tray having a tray surface with a rear edge, a front edge and a pair of side edges;
a rear support leg having a leg surface with a top edge, bottom edge and a pair of. side edges; and
at least one connection means between said tray and said rear support leg.

2. The scaffold tray and tool case of claim 1 wherein said rear edge is level with said tray surface; wherein said front edge is taller than said tray surface, wherein said pair of side edges are taller than said tray surface.

3. The scaffold tray and tool case of claim 2 wherein said rear edge further comprises at least one rung opening and at least one rung opening fastener; wherein said rung opening is positioned at the bottom of said rear edge of said tray surface; wherein said rung opening fastener is adjustably positioned below said rung opening.

4. The scaffold tray and tool case of claim 3 wherein said tray surface contains a number of tray surface openings on said tray surface, wherein said tray surface openings extend from the top of said tray surface to the bottom of said tray surface.

5. The scaffold tray and tool case of claim 4 wherein said rear support leg is attached to said tray surface by at least one of said connection means.

6. The scaffold tray and tool case of claim 5 wherein said connection means is selected from the group consisting of: fixed fastener, adjustable fastener, and folding support device.

7. The scaffold tray and tool case of claim 6 wherein said leg surface of said rear support leg further comprises at least one length of material permanently attached to two points on said leg surface; wherein said length of material may be fastenably secured to store items adjacent to said leg surface.

8. The scaffold tray and tool case of claim 7 wherein said leg surface of said rear support leg further comprises at least one opening from the interior surface of said leg surface to the exterior of said leg surface.

9. The scaffold tray and tool case of claim 6 wherein a length of material is attached to the outer surface of said front edge of said tray surface; wherein a length of material is attached to the exterior surface of said leg surface of said rear support leg.

10. A method for holding and storing tools for use with a scaffold comprising:
Attaching a rung opening at a rear edge of a tray surface to a first scaffold rung with a rung fastener in an open position;
Moving a rung fastener to a closed position;
Placing a rear support leg against a second scaffold rung;
Optionally placing tools through at least one opening of said tray surface;
Optionally placing tools against the interior surface of said rear support leg;
Securing tools placed against said interior surface of said rear support leg with a first length of material;
Securing said rear support leg to said scaffold with a second length of material placed through an opening of said rear support leg and secured to said scaffold.

11. A method for holding and storing tools for use comprising:
Placing at least one tool against a rear leg surface; Securing said tool against a rear leg surface with a first length of material;
Collapsing said folding support connecting a tray surface to said rear support leg;
Carrying said scaffold tray and tool case by a second length of material attached to an exterior edge of said tray surface.
